(19) United States
(12) Patent Application Publication
(10) Pub. No.: US 2012/0265980 A1
(43) Pub. Date: Oct. 18, 2012

(54) APPARATUS AND METHOD FOR SECURING USER INPUT DATA

(75) Inventors: Ji Uk MOON, Seoul (KR); Kwang Baek KIM, Seoul (KR)

(73) Assignee: PANTECH CO., LTD., Seoul (KR)

(21) Appl. No.: 13/332,102

(22) Filed: Dec. 20, 2011

(30) Foreign Application Priority Data
Apr. 18, 2011 (KR) 10-2011-0035866

(51) Int. Cl. G06F 21/00

(52) U.S. Cl. 713/150; 713/189

(57) ABSTRACT

An apparatus and method for securing user input data in an electronic device including an input interface. A touch panel senses touch events in an input interface, a touch integrated circuit receives coordinate data associated with the touch events and encrypts the coordinate data using a secure key. The touch integrated circuit blocks a main processor of the electronic device from being aware that a touch event has been sensed and may directly transmit the coordinate data to a server without the intervention of the main processor.

### CROSS-REFERENCE TO RELATED APPLICATION

This application claims priority from and the benefit of Korean Patent Application No. 10-2011-0035866, filed on Apr. 18, 2011, which is hereby incorporated by reference for all purposes as if fully set forth herein. This application is related to U.S. patent application Ser. No. ______, filed on ______, having attorney docket number P4592US00 which claims priority from and the benefit of Korean Patent Application No. 10-2011-0035869, filed on Apr. 18, 2011, and U.S. patent application Ser. No. ______, filed on ______, having attorney docket number P4594US00 which claims priority from and the benefit of Korean Patent Application No. 10-2011-0050565, filed on May 27, 2011, all of which are assigned to the same assignee as the current application, and all of which are incorporated by reference in its entirety as if fully set forth herein.

### BACKGROUND

1. Field

The following description relates to a method and apparatus to secure user input data in an electronic device, an electronic device employing the method and apparatus, and a communication system for user input data.

2. Discussion of the Background

Applications requiring privacy, such as, a financial program, have been frequently used in smart phones, tablet personal computers (PCs), and the like. However, the applications may be vulnerable to hacking of the electronic device and the like. For example, an electronic device using an open source operating system (OS) may be vulnerable to hacking.

A method using a virtual keyboard provided on a web server may be used to protect the privacy of user input data, also referred to as data input by a user. However, the method using the virtual keyboard may access the web server and thus, may be vulnerable to hacking.

A conventional touch IC may not encrypt a user input data that is input via a touch panel even in a secure mode. According to the conventional art, data input by the user may be directly sensed by a main processor of an electronic device and encryption may be controlled by the main processor. Therefore, according to the conventional art, if the main processor of the electronic device is hacked, important information of the user may be leaked.

### SUMMARY

Exemplary embodiments of the present invention provide an apparatus and a method for protecting information or data input by a user.

Exemplary embodiments of the present invention also provide a method and apparatus to provide security using a touch screen or a touch panel.

Additional features of the invention will be set forth in the description which follows, and in part will be apparent from the description, or may be learned by practice of the invention.

An exemplary embodiment of the present invention discloses an apparatus to secure input data, including: a touch panel to receive an input data; a touch integrated circuit to encrypt input data; and a main processor to receive encrypted input data; wherein the touch integrated circuit blocks the main processor from being aware of the content of the input data.

An exemplary embodiment of the present invention also discloses a method for securing input data in a touch integrated circuit, including: obtaining a first coordinate data associated with a first touch event of an input of data in a touch panel; storing the first coordinate data; determining if an input of data is completed in the touch panel; generating a first feedback signal; if the input of data is completed encrypting the first coordinate data using a secure key; if the input of data is not completed: obtaining a second coordinate data associated with a second touch event of the input of data in a touch panel; storing the second coordinate data; generating a second feedback signal; determining if the input of data is completed in the touch panel; and if the input of data is completed, encrypting the first and second coordinate data using a secure key.

A method for securing user input data in an electronic device, including: in a secure mode, providing an input interface to receive input data; blocking a main processor from being aware of the content of input data; receiving coordinate data about a touch event in a touch integrated circuit; encrypting the coordinate data in the touch integrated circuit using a secure key; and transmitting the encrypted coordinate data.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a method for securing user input data according to an exemplary embodiment of the present invention.

FIG. 2 is a block diagram illustrating an electronic device according to an exemplary embodiment of the present invention.

FIG. 3 is a block diagram illustrating a touch integrated circuit (IC) according to an exemplary embodiment of the present invention.

FIG. 4 is a diagram illustrating a method for securing user input data according to an exemplary embodiment of the present invention.

FIG. 5A is a diagram illustrating a method for securing user input data according to an exemplary embodiment of the present invention.

FIG. 5B is a diagram illustrating a method for securing user input data according to an exemplary embodiment of the present invention.

FIG. 6 is a diagram illustrating an input interface according to an exemplary is embodiment of the present invention.

FIG. 7 is a diagram illustrating a screen display according to an exemplary embodiment of the present invention.

FIG. 8 is a diagram illustrating a method for obtaining a secure key according to an exemplary embodiment of the present invention.

### DETAILED DESCRIPTION OF THE ILLUSTRATED EMBODIMENTS

Exemplary embodiments are described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity, illustration, and convenience

It will be understood that when an element is referred to as being “connected to” another element, it can be directly connected to the other element, or intervening elements may be present. In contrast, if an element is referred to as being “directly” connected to another element, no intervening elements are present.

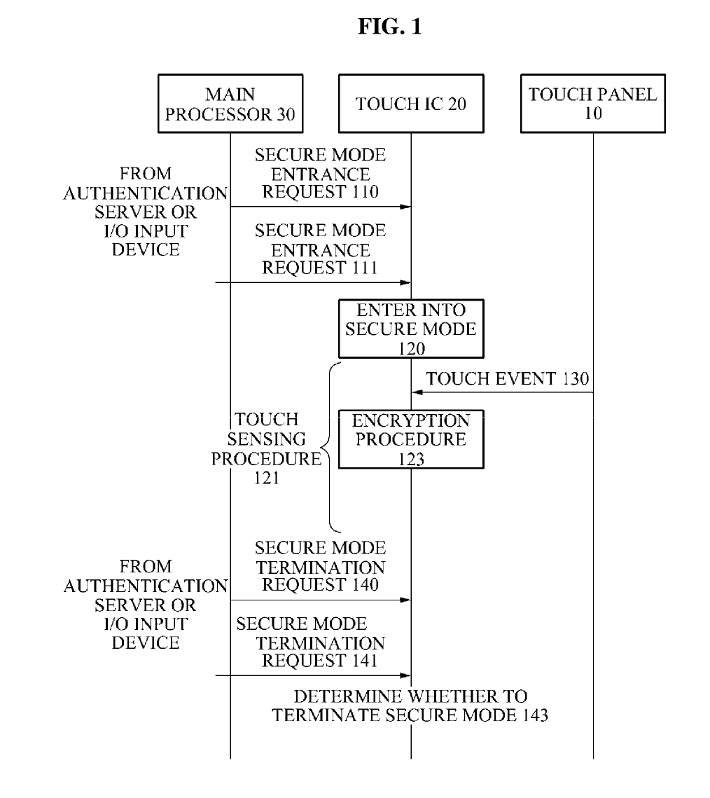

FIG. 1 is a diagram illustrating a method for securing user input data according to an exemplary embodiment of the present invention.

Referring to FIG. 1, a touch integrated circuit (IC) 20 encrypts the user input data is in an operation of receiving the user input data from a touch panel 10. Therefore, a main processor 30 of an electronic device may not receive the unencrypted user input data. The touch IC 20 may encrypt data that is input via the touch panel 10 and may not perform encryption if an electronic device is in a non-secure mode. The input data may be provided by a user or an apparatus communicating with the IC 20. However, for the simplicity in disclosure, inputs provided by the user or the apparatus may be referred to as “user input” or simply “input.”

Various methods may be used to enable the main processor 30 of the electronic device to be unaware of the user input data in a secure mode. Non-limiting examples of such methods include:

1) Method 1: corresponds to a method that enables the main processor 30 of the electronic device to not recognize, sense or detect a touch input that may be received during the secure mode. For example, in the secure mode, the touch IC 20 may enable the main processor 30 to not sense the touch event or touch input by blocking a physical or software connection path between the touch IC 20 and the main processor 30 or between the touch panel 10 and the main processor 30.

2) Method 2: corresponds to a method in which the touch event or touch input may be sensed by the main processor 30 of the electronic device, and data corresponding to the touch input, which may be encrypted after the touch event or touch input is sensed, may not be transferred to the main processor 30 of the electronic device. In this method, the touch IC 20 may transmit encrypted input data to a server via a communication module of the electronic device without intervention of the main processor 30.

3) Method 3: corresponds to a method in which the touch event or touch input may be sensed by the main processor 30 of the electronic device, and data corresponding to the is touch input, which may be encrypted after the touch event or touch input is sensed, may be transferred to the main processor 30 of the electronic device. In this method, the input data may be encrypted by the touch IC 20 and thus, the main processor 30 may be unaware the information included in the encrypted data corresponding to the touch input.

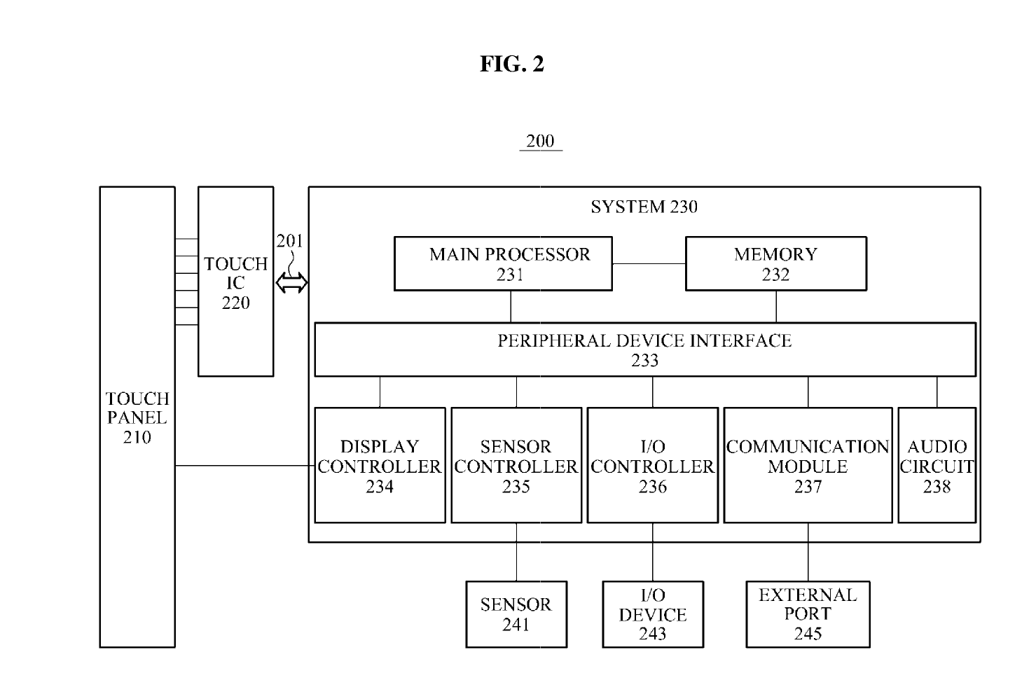

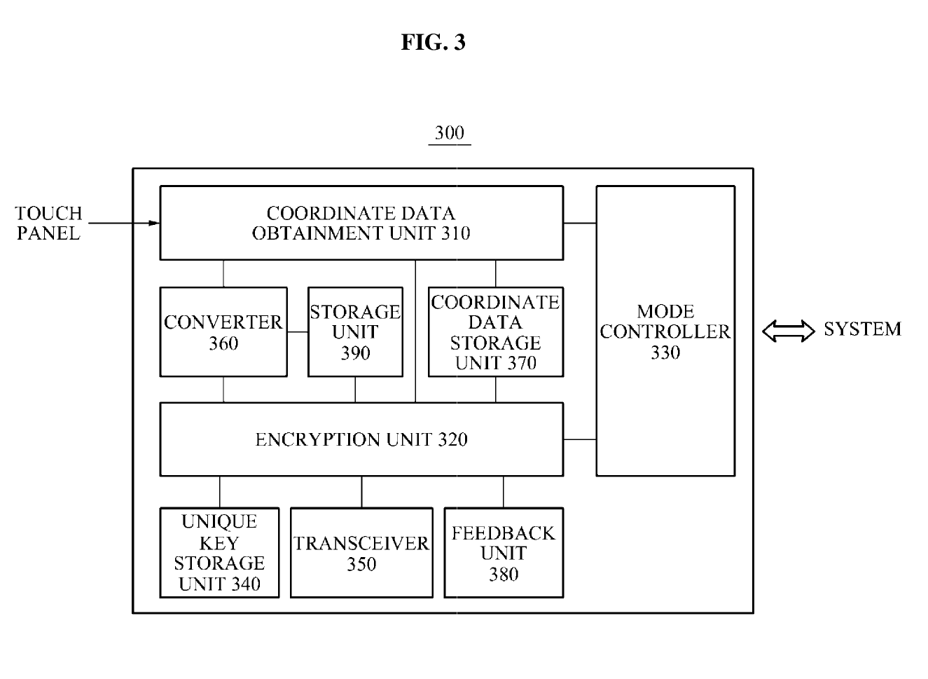

Method 1, Method 2, and Method 3 will be further described with reference to FIG. 2 and FIG. 3. The above Method 1, Method 2, and Method 3 are provided as examples for enabling the main processor 30 of the electronic device to become unaware of what the input data is and are not limitations on the present invention. Therefore, various embodiments for preventing a main processor 30 from being aware of input data may be configured.

Referring again to FIG. 1, in operation 110 or operation 111, the touch IC 20 may receive a request signal to enter a secure mode or a secure mode entrance request signal to request entrance into the secure mode or to initiate a secure mode. The secure mode may be requested if an application requiring security is executed. The application requesting the security may be, for example, an application associated with banking, an application containing personal information of the user, private contact information, and the like. The secure mode may be requested if an input of a password is required, such as a case in which the electronic device accesses an external server to log in, a case in which an application is to be purchased in an application store, and the like. Operation 110 corresponds to a case in which the secure mode entrance request signal is received via the main processor 30, and operation 111 corresponds to a case in which the secure mode entrance request signal is directly or indirectly received by the touch IC 20 without intervention of the main processor 30.

In operation 110 or operation 111, the secure mode entrance request signal may occur if a user inputs a number or a pattern via the touch panel 10, if a motion of the user or the is electronic device is sensed via a sensor, if an input of a number or a pattern using other input devices excluding the touch panel occurs, and the like. Also, the user may manipulate the electronic device to execute the secure mode by touching a number or button on the input interface.

In operation 111, the secure mode entrance request signal may be received from an authentication server over a network. The authentication server may be a server that requests encrypting of an object to transmit the encrypted object. For example, a server of a financial company may be the authentication server. The authentication server may be a separate server for authenticating the user. If the secure mode entrance request signal is received from the authentication server, the received secure mode entrance request signal may be configured to be directly transferred from a communication module to the touch IC 20 without intervention of the main processor 30.

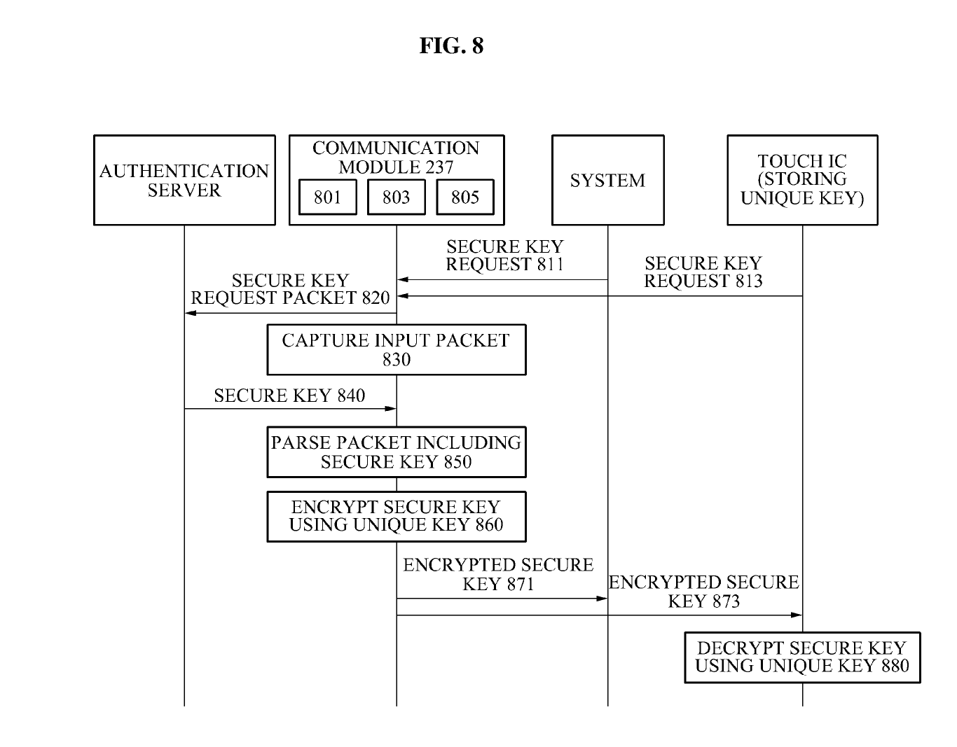

In operation 110 or operation 111, the main processor 30 may transmit information about an area of the input interface occupied by the touch panel 10, or conversion based data to the touch IC 20. The secure key may be a key value that is used to encrypt the user input data. The “secure key” may be a key value that is used when the touch IC 20 encrypts the user input data. The secure key may be a symmetric key or an asymmetric key. The secure key may be transferred from the main processor 30 to the touch IC 20, or may be embedded in the touch IC 20. The secure key embedded in the touch IC 20 may be a key value that is stored in a secure memory area inaccessible from an outside and is allocated in production of the touch IC 20. The secure key may be received from the authentication server as shown in, for example, a method of FIG. 8. The secure memory area of the touch IC 20 may store information about the area of the input interface occupied by the touch panel 10 or conversion based data. The secure memory area may be configured to be accessible using a reference key.

If the secure mode entrance request signal is received, the touch IC 20 may enter into the secure mode in operation 120. The secure mode may be a mode for encrypting data input from the user. In the secure mode, the touch IC 20 may activate an encryption unit that performs an encryption algorithm.

If a touch event 130 occurs in the secure mode, the touch IC 20 may perform an encryption procedure 123. The encryption procedure 123 may be reference procedures for encrypting the user input data. For example, the encryption procedure 123 may include a procedure of encrypting coordinate data. The encryption procedure 123 may include a procedure of encrypting N pieces of coordinate data. The encryption procedure 123 may include a procedure of the touch IC 20 to encrypt a user input value. The touch IC 20 may perform a touch sensing procedure 121 periodically in the secure mode. The touch sensing procedure 121 may be reference procedures for sensing a touch event. The touch sensing procedure 121 may include a procedure of sensing the occurrence of the touch event 130 by scanning the touch panel 10 at reference intervals.

In the secure mode, the touch IC 20 may perform optimization of the encryption of data. For example, in the secure mode, the touch IC 20 may adjust a system resource allocation with respect to the touch sensing procedure 121 of sensing the touch event 130 and the encryption procedure 123 of encrypting the coordinate data. In the secure mode, the touch IC 20 may allocate a relatively large amount of system resources to the encryption procedure 123 compared to the touch sensing procedure 121. For example, the touch IC 20 may decrease an amount of system resources allocated to the touch sensing procedure 121 by increasing the interval between scanning the touch panel 10. The touch IC 20 may perform encryption after a is user input is completed in the secure mode and thus, may allocate a relatively large amount of system resources to the encryption procedure 123 if the user input is completed, i.e., if coordinate data of the touch event is obtained.

If the data input of the user is completed in the secure mode, or if there is a need to terminate the secure mode, the touch IC 20 may receive a secure mode termination request signal in operation 140 or operation 141. The secure mode termination request signal is a signal for requesting termination of the secure mode. Whether data input of the user is completed may be recognized using various schemes. For example, if a password is input, if a reference number of digits is input, if a complete key is touched, if a login key is touched, or if a touch event does not occur for a reference period of time, the data input of the user may be determined to have been completed. Like the secure mode entrance request signal, the secure mode termination signal may occur if an input of a reference number or a reference pattern is sensed via the touch panel 10, if a reference motion of the user or an electronic device is sensed via a sensor, if an input of a reference number or a reference input pattern using other input devices excluding the touch panel 10 occurs is sensed, and the like. Similar to the secure mode entrance request signal, the secure mode termination signal may be received from the authentication server.

In operation 143, the touch IC 20 may determine whether to terminate the secure mode. If data input of the user is determined to have been completed in the secure mode, the touch IC 20 may terminate the secure mode. If the secure mode is terminated, or if the secure mode termination request signal is received, the touch IC 20 may deactivate the encryption unit.

If the data input of the user is completed, or if the secure mode is terminated, the touch IC 20 may delete all the data excluding the encrypted data.

Data encrypted using the secure key may be decrypted in a server having a is decryption key corresponding to the secure key. Here, the decryption key corresponding to the secure key may be an encryption key that is the same as the secure key used to encrypt the user input data, or that has a pair relationship with the secure key used to encrypt the user input data.

FIG. 2 is a block diagram illustrating an electronic device according to an exemplary embodiment of the present invention.

Referring to FIG. 2, an electronic device 200 may include a touch panel 210, a touch IC 220, and a system 230. In FIG. 2, the touch panel 210 and the touch IC 220 may correspond to a user input data securing apparatus of an electronic device according to an exemplary embodiment. The electronic device 200 may further include a sensor 241, an input/output (I/O) device 243, and an external port 245.

The touch panel 210 may provide an input interface for data input by a user. The touch panel 210 may display a keyboard to enable the user to input a number, a character, a symbol, and the like, using a touch. The keyboard displayed on the touch panel 210 is an example of the input interface and the input interface may be provided in various forms. The touch panel 210 may include a touch screen. Accordingly, the touch panel 210 may include a touch sensing area and a display area.

The touch IC 220 may be connected to the touch panel 210 to sense an electrical signal received from the touch panel 210. The touch IC 220 may encrypt data input via the touch panel 210 in the secure mode. The touch IC 220 may perform encryption in the secure mode and may not perform encryption in a non-secure mode. A program to perform various types of encryption algorithms may be embedded in the touch IC 220. The touch IC 220 may convert the received electrical signal into data having a reference value and may encrypt the converted data. Here, the touch IC 220 may encrypt data using a secure key. For example, the touch IC 220 may is encrypt coordinate data about a location where a touch event occurs. The touch IC 220 may convert the coordinate data to numbers or characters, and may then encrypt the numbers or the characters. Encryption may be performed while the touch IC 220 receives a user input in the secure mode. In the secure mode, the encryption performed by the touch IC 220 may be independently performed without intervention of the system 230.

According to Method 1, the touch IC 220 may block a transfer path 201 of the touch event so that the touch event occurring in the secure mode may not be sensed by a main processor 231 of the electronic device 200. According to Method 1, the main processor 231 may be configured to not sense the occurrence of the touch event itself. In the secure mode, the system 230 may not sense the occurrence of the touch event.

According to Method 2, the touch IC 220 may transfer, to the system 230 or the main processor 231, information about whether the touch event has occurred in the secure mode. The touch IC 220 may block the transfer path 201 of coordinate data or a user input value so that the coordinate data or the user input value may not be sensed by the main processor 231.

According to Method 3, the touch IC 220 may transfer, to the system 230 or the main processor 231, information about whether the touch event has occurred in the secure mode, and may transfer encrypted coordinate data or an encrypted user input value to the system 230 or the main processor 231.

In Method 2 or Method 3, information about whether the touch event has occurred may be transferred to the system 230 or the main processor 231 in a form of a feedback signal regardless of the form of the user input data. The feedback signal will be further described with reference to FIG. 3. According to Method 2 or Method 3, in the secure mode, the system 230 may become aware of whether the touch event has occurred, however, the system 230 may be is unaware of what the user input value is because encrypted data is received.

The touch IC 220 may sense an electrical signal received from the touch panel 210 to be aware that the touch event has occurred via the input interface. The touch event may occur using a finger of the user. The touch event may also occur using an instrument such as a stylus. Touch events may include, for example, a gesture, a drag, a tap, a multi-tap, a flick, and the like. If the touch event occurs via the input interface, the touch IC 220 may encrypt coordinate data about an occurrence location of the touch event or a user input value that is converted from the coordinate data to a value corresponding to the user input data using the secure key.

The system 230 may include the main processor 231, a memory 232, a peripheral device interface 233, a display controller 234, a sensor controller 235, an I/O controller 236, a communication module 237, and an audio circuit 238. The term “system 230” or “system” may be used to indicate components excluding the touch panel 210 and the touch IC 220 from among components included in the electronic device 200. Each of the components included in the system 230 may perform communication via at least one communication bus or signal line. Each of the components may be configured by hardware, software, or a combination thereof.

The main processor 231 may signal to change an operation mode of the touch IC 220. The main processor 231 may transmit, to the touch IC 220, a secure mode entrance request signal to request entrance into the secure mode, described above in operation 110. The main processor 231 may provide conversion based data to the touch IC 220. The conversion based data may include coordinate information allocated to number keys, character keys, or symbol keys that are provided via the input interface. The conversion based data will be described in further detail below.

The main processor 231 may include multiple processors. The main processor 20 may include multiple processors that are configured to perform multiple functions.

The memory 232 may include, for example, a high-speed random access memory (HSRAM), a magnetic disk, a static random access memory (SRAM), a read only memory (ROM), a flash memory, a non-volatile memory, and the like. The memory 232 may store a software module for an operation of the electronic device 200, a set of commands, other data, and the like.

The peripheral device interface 233 may combine a peripheral input and/or output device of the electronic device 200 with the main processor 231 and the memory 232.

The display controller 234 may display a visual output by controlling the touch panel 210. For example, the display controller 234 may receive a feedback signal from the touch IC 220 and display a reference symbol in response. In an exemplary embodiment, the display controller 234 may directly display the feedback signal without intervention by the main processor 231.

The sensor controller 235 may control various sensors 241 included in the electronic device 200 and receive sensing data from the sensor 241. For example, the sensor controller 235 may activate or deactivate a gyro sensor, a terrestrial magnetic sensor, and the like. The sensor 241 may be configured to include multiple sensors. For example, the sensor 241 may include a motion sensor, a gyro sensor, a terrestrial magnetic sensor, and the like.

The I/O controller 236 may transmit a signal to the I/O device 243 or may receive a signal from the I/O device 243. For example, the I/O device 243 may include a physical button, a light emitting diode (LED), a physical keyboard, a vibration motor, and the like.

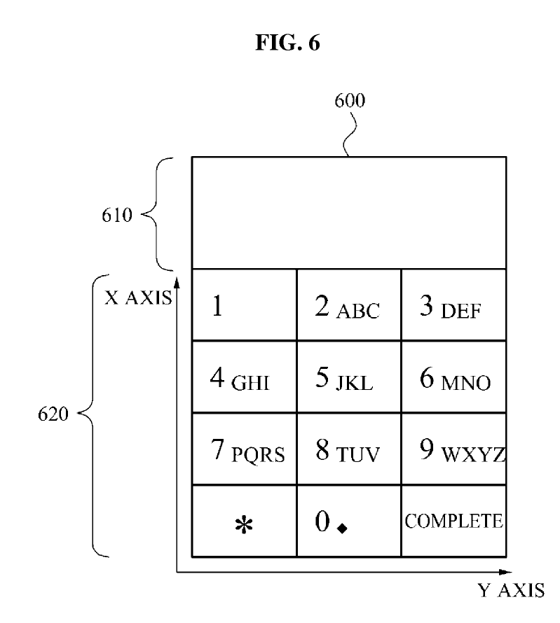

The communication module 237 may transmit data, received from the touch IC 220, to a server. The communication module 237 may transmit the received data to the server without intervention of the main processor 231. If the touch event occurs, the communication module 237 may transmit the encrypted coordinate data or the encrypted user input value to the server. The user input value will be further described with reference to FIG. 6.

As shown in FIG. 8, the communication module 237 may include a unique key storage unit 801, a parsing unit 803, and an encryption unit 805. The communication module 237 may be configured as an IC. The unique key storage unit 801, the parsing unit 803, and the encryption unit 805 will be described in greater detail with reference to FIG. 8.

Referring again to FIG. 2, the communication module 237 may include a radio frequency (RF) circuit to convert an electrical signal into an electromagnetic signal or to convert the electromagnetic signal into the electrical signal, and to communicate with a communication network using the electrical signal. The communication module 237 may include at least one circuit element for performing communication using, for example, Global System for Mobile Communications (GSM), Enhanced Data GSM Environment (EDGE), wideband code division multiple access (W-CDMA), code division multiple access (CDMA), time division multiple access (TDMA), Bluetooth®, Institute of Electrical and Electronics Engineers (IEEE) 802.11a, IEEE 802.11b, IEEE 802.11g and/or IEEE 802.11n, and the like, Wireless Fidelity (Wi-Fi), voice over Internet Protocol (VoIP), Wi-MAX®, Long Term Evolution (LTE)®, radio frequency identification (RFID), Near Field Communication (NFC), and the like.

The audio circuit 238 may provide an audio interface between a user and the electronic device 200 using a speaker and/or a microphone.

The external port 245 may be an interface connected to an external device. For example, the external port 245 may include a universal serial bus (USB) port, an external is monitor connection port, and the like.

FIG. 3 is a block diagram illustrating a touch IC according to an exemplary embodiment of the present invention.

Referring to FIG. 3, a touch IC 300 may include a coordinate data obtainment unit 310 and an encryption unit 320. The touch IC 300 may further include a mode controller 330, a unique key storage unit 340, a transceiver 350, a coordinate data storage unit 370, and a feedback unit 380. The touch IC may also include a converter 360 and a storage unit 390.

If a touch event occurs via an input interface, the coordinate data obtainment unit 310 may obtain coordinate data about an occurrence location of the touch event. In an exemplary embodiment, the coordinate data may be an X axis coordinate and a Y axis coordinate indicating a reference location on a touch panel.

In an exemplary embodiment, if a touch event occurs, the encryption unit 320 may encrypt the coordinate data about the occurrence location of the touch event using a secure key. The encryption unit 320 may also encrypt the user input value using the secure key. If data input of a user is completed, the encryption unit 320 may encrypt N pieces of coordinate data that are stored in the coordinate data storage unit 370 using the secure key. If the data input of the user is completed, the encryption unit 320 may encrypt N user input values with respect to the N touch events, respectively. In an exemplary embodiment, the encryption unit 320 may encrypt the N pieces of coordinate data or the N user input values at one time by treating the N pieces of coordinate data or the N user input values as a single encryption target, or may perform encryption an N number of times by treating each of the N pieces of coordinate data or the N user input values as an encryption target. For example, when N=4, secure key=“PKey,” and user input values are “1, 2, 3, 4,” the encryption unit 320 may perform encryption as “(1, 2, 3, 4)**PKey,” or may perform encryption as “1** PKey,” “2** PKey,” “3** PKey,” and “4** PKey.” Here, “**” indicates an encryption operator. The encryption unit 320 may encrypt coordinate data using various encryption algorithms capable of encrypting data, in addition to an encryption scheme using the secure key.

If a secure mode entrance request signal requesting entrance into a secure mode is received, the mode controller 330 may activate the encryption unit 320. If a secure mode termination request signal requesting termination of the secure mode is received, the mode controller 330 may deactivate the encryption unit 320.

According to Method 1, the mode controller 330 may control the touch IC 300 such that a touch event occurring in the secure mode may not be sensed by a main processor of an electronic device. A according to Method 2, the mode controller 330 may transfer, to a system or the main processor, information about whether the touch event has occurred in the secure mode, and may control the touch IC 300 so that coordinate data or a user input value may not be sensed by the main processor. According to Method 3, the mode controller 330 may transfer, to the system or the main processor, information about whether the touch event has occurred in the secure mode, and may control the touch IC 300 to transfer encrypted coordinate data or an encrypted user input value to the system or the main processor.

In the secure mode, the mode controller 330 may adjust a system resource allocation with respect to a touch sensing procedure to sense the touch event and an encryption procedure to encrypt the coordinate data. In the secure mode, the mode controller 330 may allocate a relatively large amount of system resources to the encryption procedure compared to the touch sensing procedure.

If the secure mode termination request signal is received, the mode controller 330 is may delete N pieces of coordinate data that are stored in the coordinate data storage unit 370.

The unique key storage unit 340 may store a unique key that is allocated to the touch IC 300 and a communication module of the electronic device.

The feedback unit 380 may generate a feedback signal indicating that a touch is sensed for each touch event, and may provide the feedback signal to an application being executed or a display controller. The feedback signal may correspond to a random value or a reference unique value. For example, the feedback signal may be X and Y coordinates of a reference area, instead of actual coordinate data. If the system receives the feedback signal, the system may notify the user that the touch is sensed using a vibration, LED lighting, displaying of a reference symbol, and the like. In an exemplary embodiment, the feedback signal may correspond to a random value or a reference unique value. For example, regardless of what the user input value is, a reference signal and the like may be used as the feedback signal and therefore the main processor is not aware of the content of user input data if a feedback signal is used.

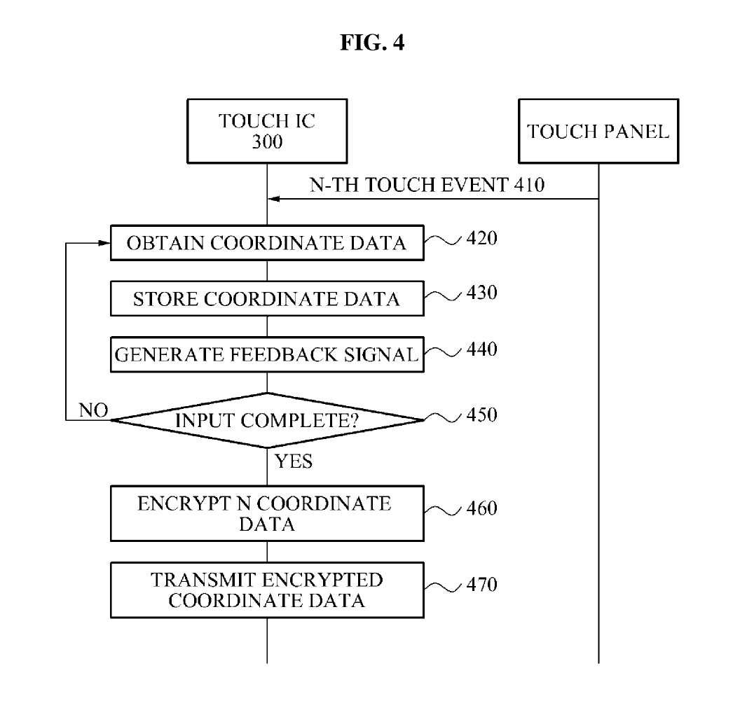

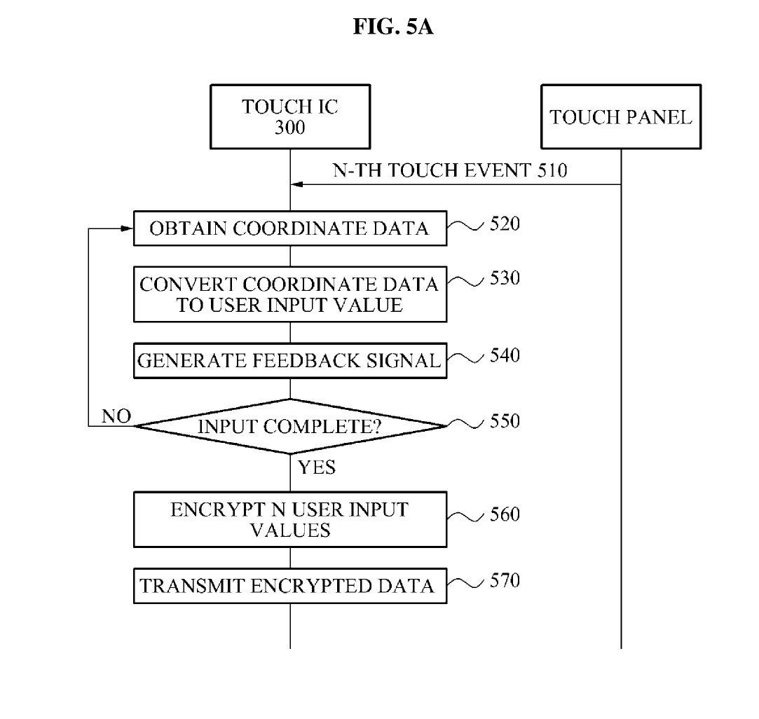

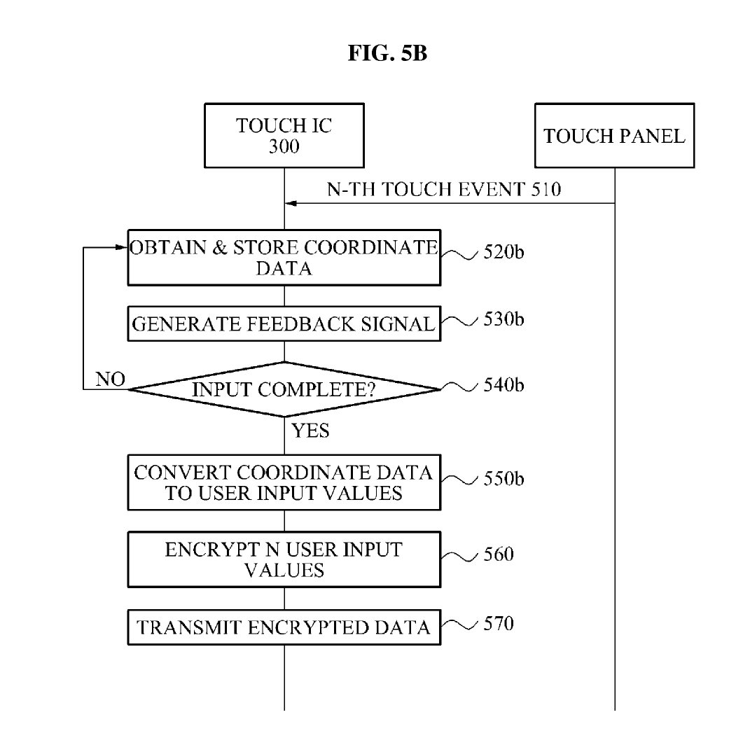

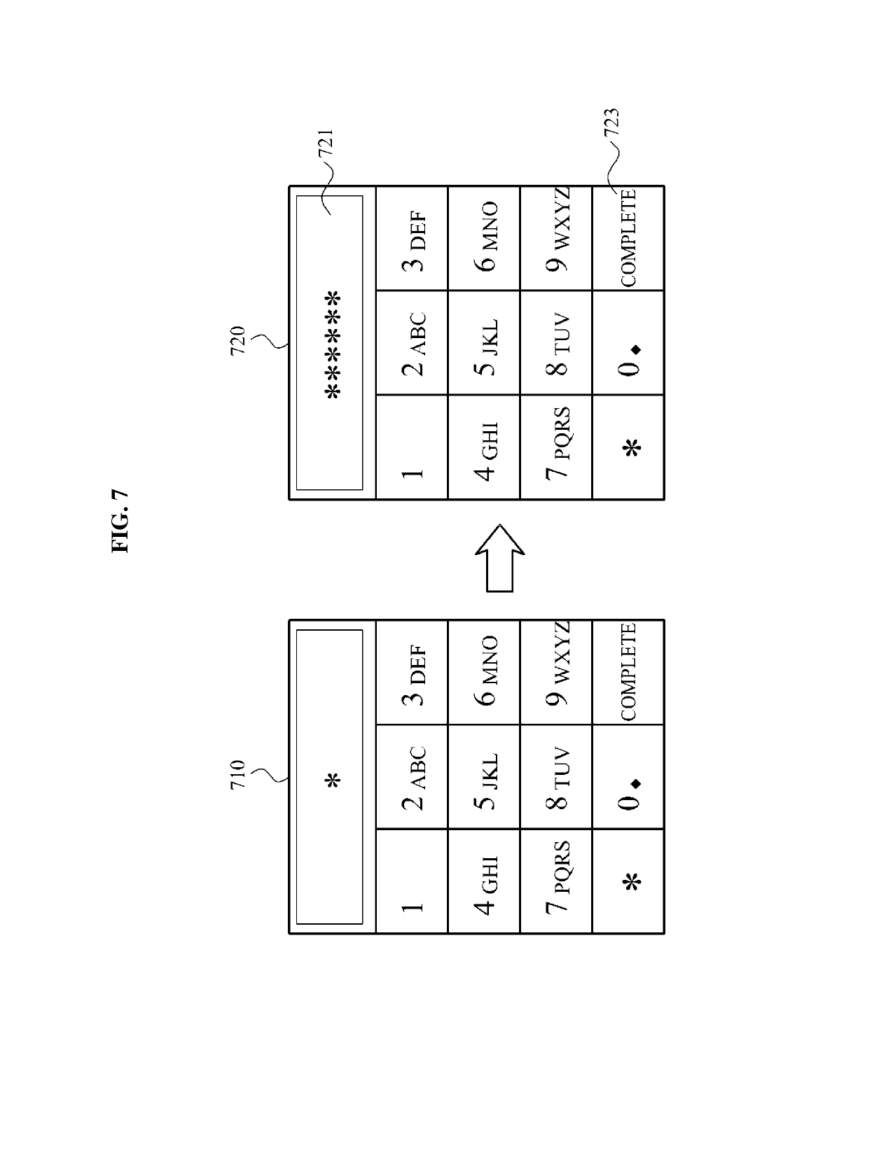

Hereinafter, constituent elements of the touch IC 300 will be further described with reference to FIG. 4, FIG. 5A, FIG. 5B, FIG. 6, FIG. 7, and FIG. 8.

FIG. 4 is a diagram illustrating a method for securing user input data according to an exemplary embodiment of the present invention.

Referring to FIG. 4, in operation 410 an N-th touch event occurs. In operation 420, the coordinate data obtainment unit 310 may obtain coordinate data about an occurrence location of the touch event. For example, an N-th touch event indicates that N touch events have occurred after entering into the secure mode. The coordinate data may be an X-axis coordinate and a Y-axis coordinate of the touch panel. The coordinate data obtainment unit 310 may is calculate coordinate data based on a change in a capacitance, an amount of current, and the like, of a touch sensor. The coordinate data obtainment unit 310 may calculate the coordinate data using a change in an electrical resistance of the touch sensor and the like. The touch sensor may be configured using various schemes, for example, a capacitive type, a decompression type, and the like.

In operation 430, the coordinate data storage unit 370 may store N pieces of coordinate data about respective corresponding occurrence locations of N touch events. N denotes an integer greater than or equal to 1. The N pieces of coordinate data may be stored in order to encrypt the whole user input data after data input by the user is completed.

In operation 440, the feedback unit 380 may generate a feedback signal indicating that a touch is sensed for each touch event, and may provide the feedback signal to an application being executed or a display controller.

In operation 450, the encryption unit 320 may determine whether a data input by the user is completed. If the data input of the user is not completed, the touch IC 300 may perform operation 420 depending on whether a new touch event has occurred.

If the data input by the user is completed, the encryption unit 320 may encrypt the stored N pieces of coordinate data using the secure key in operation 460. The secure key may be a key value for an asymmetric encryption. As described above with reference to FIG. 3, the encryption unit 320 may encrypt the N pieces of coordinate data at one time by treating the N pieces of coordinate data as a single encryption target, or may perform encryption an N number of times by treating each of the N pieces of coordinate data as an encryption target.

In operation 470, the transceiver 350 may transmit the encrypted coordinate data to the server via the communication module of the electronic device. According to Method 1 or is Method 2, the transceiver 350 may directly transfer the encrypted coordinate data to the communication module without intervention by the main processor. According to Method 3, the transceiver 350 may transfer the encrypted data to the communication module via the main processor of the electronic device. The transceiver 350 may transmit, to the server via the communication module, information about a resolution of the touch panel, a size of the touch panel, and a location of the input interface in the touch panel, specification information of the touch panel, specification information of the electronic device, etc. The specification information of the electronic device or the touch panel may be transmitted to the server to enable the server to decrypt encrypted coordinate data and thereby be aware of a user input value using the coordinate data. Since coordinate data with respect to the same user input may vary based on the size of the touch panel, the transceiver 350 may transmit the specification information of the electronic device or the touch panel to the server. The server may become aware of the user input value from the coordinate data using a lookup table in which the coordinate data and the user input value are mapped.

FIG. 5A is a diagram illustrating a method for securing user input data according to an exemplary embodiment of the present invention.

In operation 510, an N-th touch event occurs. The coordinate data obtainment unit 310 may obtain coordinate data about an occurrence location of the touch event in operation 520. For example, an N-th touch event indicates that N touch events have occurred after entering into a secure mode.

In operation 530, the converter 360 may convert the coordinate data into a user input value corresponding to user input data. The converter 360 may store the user input value in a storage unit 390. Accordingly, if the touch event occurs an N number of times, the storage unit 390 may store N user input values corresponding to N touch events. The converter 360 may convert the coordinate data into a user input value corresponding to the user input data based on the conversion based data. The conversion based data may include coordinate information allocated to number keys, character keys, or symbol keys that are provided via the input interface. For example, X axis coordinate 0.1 to 1.0 and Y axis coordinate 2.5 to 3.0 may be allocated to a number key “1,” and X axis coordinate 1.01 to 2.0 and Y axis coordinate 2.5 to 3.0 may be allocated to a number key “2.” If coordinate data=(0.8, 2.6), the user input value may be “1.” If coordinate data=(1.5, 2.6), user input value may be “2.” The converter 360 may provide, to the encryption unit 320, a value that is obtained by applying a reference operation to an actual user input value. If the type of the input interface is changed, or if the input interface keeps changing, the conversion based data may include information that is changed based on the type of the input interface. For example, if the arrangements of numbers displayed on the input interface change at reference intervals, the conversion based data may also need to be changed. Accordingly, the system may provide the changed conversion based data to the touch IC 300.

The conversion based data may be stored in the touch IC 300, or may be directly received from the server via the communication module of the electronic device.

In operation 540, the feedback unit 380 may generate a feedback signal indicating that a touch is sensed for each touch event and may provide the feedback signal to an application being executed or a display controller.

In operation 550, the encryption unit 320 may determine whether a data input by the user is completed. If the data input of the user is not completed, the touch IC 300 may perform operation 520 depending on whether a new touch event has occurred

If the data input by the user is completed, the encryption unit 320 may encrypt the is stored N user input values about corresponding N touch events in operation 560. N denotes an integer greater than or equal to “1.” In other words, the encryption unit 320 recognizes if the data input by the user is completed, the encryption unit 320 may encrypt the N user input values using the secure key in operation 560. As described above with reference to FIG. 3, the encryption unit 320 may encrypt the N user input values at one time by treating the N user input values as a single encryption target, or may perform encryption an N number of times by treating each of the N user input values as an encryption target.

In operation 570, the transceiver 350 may transmit the encrypted data to the server.

FIG. 5B is a diagram illustrating a method for securing user input data according to an exemplary embodiment of the present invention.

Referring to FIG. 5B, if an N-th touch event occurs in operation 510, the coordinate data obtainment unit 310 may obtain coordinate data about an occurrence location of the touch event and store the obtained coordinate data in the coordinate data storage unit 370 in operation 520b. The coordinate data storage unit 370 may store N pieces of coordinate data about the corresponding occurrence locations of N touch events. N denotes an integer greater than or equal to “1.”

In operation 530b, the feedback unit 380 may generate a feedback signal indicating that a touch is sensed for each touch event, and may provide the feedback signal to an application being executed or a display controller.

In operation 540b, the encryption unit 320 or the converter 360 may determine whether data input by the user is completed. If the data input by the user is not completed, the touch IC 300 may perform operation 520b depending on whether a new touch event occurs.

If the data input by the use is completed, the converter 360 may convert the stored N pieces of coordinate data into N user input values corresponding to the user input data, in operation 550b. For example, if the data input by the user is determined to be completed, the converter 360 may convert the N pieces of coordinate data into the N user input values corresponding to the user input data, in operation 550b.

In operation 560, the encryption unit may encrypt the N user input values using the secure key.

In operation 570, the transceiver 350 may transmit the encrypted data to the server.

FIG. 6 is a diagram illustrating an input interface according to an exemplary embodiment of the present invention.

Referring to FIG. 6, the input interface of touch panel 600 corresponds to a number keyboard and may be displayed on an area 620 of the touch panel 600. A symbol, for example, “*” and the like may be displayed on an area 610 where the input interface is not displayed, based on a feedback signal. Conversion based data may include coordinate data of the areas 610 and 620. In an exemplary embodiment of FIG. 6, if the user touches “1,” a user input value may be “1” and coordinate data may be a coordinate value on the X axis and Y axis where the touch has occurred in the area 620.

FIG. 7 is a diagram illustrating a screen display according to an exemplary embodiment of the present invention.

Referring to FIG. 7, on a screen 710, a single touch event has occurred in an encryption mode. On a screen 720, six touch events have occurred in the encryption mode. Six “*” displayed on a display area 721 of the screen 720 may correspond to a kind of feedback signal. In an exemplary embodiment of FIG. 7, if the touch IC 300 senses that a complete button 723 is touched, the touch IC 300 may determine that data input by a user is completed. If the user input is set to be automatically completed if six numbers are input, the touch IC 300 may determine that the data input by the user is completed without the need to sense that the complete button 723 has been touched.

FIG. 8 is a diagram of a method of obtaining a secure key according to an exemplary embodiment of the present invention.

Referring to FIG. 8, the unique key storage unit 801 of the communication module 237 may store the same unique key as a unique key stored in a touch IC. The unique key may be assigned during production of the communication module 237 of an electronic device. Accordingly, the unique key may correspond to a key value that is stored in a secure memory area inaccessible from an outside of the electronic device.

In operation 811 a system may transmit a secure key request message for requesting a secure key to the communication module 237. In operation 813, the touch IC may transmit a secure key request message for requesting a secure key to the communication module 237.

In operation 820, the communication module 237 may generate a secure key request packet and transmit the secure key request packet to an authentication server.

In operation 830, the communication module 237 may capture a packet received from the authentication server. Capturing of the packet may indicate verifying whether a packet including the secure key is received by decoding only a header of the received packet. Capturing of the packet may be performed if a reference period of time elapses after transmission of the secure key request packet to the authentication server.

In operation 840, the authentication server may generate a new secure key or may transmit a stored secure key to the communication module 237.

In operation 850, the parsing unit 803 of the communication module 237 may parse the secure key from among packets received from the authentication server, and may transfer the parsed secure key to the encryption unit 805 of the communication module 237.

In operation 860, the encryption unit 805 may encrypt the parsed secure key using the unique key stored in the unique key storage unit 801.

In operation 873, the encryption unit 805 may transfer the secure key encrypted using the unique key to the touch IC. In operation 871, the secure key encrypted using the unique key may be transferred to the touch IC via a system.

In operation 880, the encryption unit 805 may receive the secure key encrypted using the unique key from the communication module 237 and decrypt the secure key encrypted using the unique key stored in the unique key storage unit 801.

In an exemplary embodiment, a touch IC may randomly transmit user input data to a changed server while in a secure mode.

Although a touch panel and the touch IC are described above as, exemplary embodiments may be applied to other input devices. For example, it is possible to receive a user input command using a gyro sensor, a voice input, and the like, and to encrypt a sensing value using a sensor controller including an IC. The sensor controller may encrypt a sensing value itself and may transmit the encrypted sensing value without intervention by a main processor.

An input interface may receive a multi-touch input. For example, an electronic device may arrange multiples of the same numbers on a touch panel, and may determine that the user input is competed if the user simultaneously touches the same numbers. Here, the numbers is may be randomly arranged. For example, a number pad of Table 1 may be displayed as the input interface.

TABLE 1

| | | | | |
|---|---|---|---|---|
| 3 | 6 | 1 | 7 | 6 |
| 8 | 2 | 4 | 2 | 8 |
| 5 | 5 | 3 | 9 | 0 |
| 9 | 1 | 4 | 7 | 0 |

In an exemplary embodiment, if the multiples of same numbers are simultaneously touched, a coordinate data obtainment unit included in a touch IC may be configured to obtain coordinate data about an occurrence location of a touch event. For example, if two “6”s are simultaneously touched on Table 1, the coordinate data obtainment unit may obtain coordinate about “6” located in a first line and a second column or coordinate data about “6” located in the first line and a fifth column. Accordingly, it is possible to more accurately obtain a user input value.

According to exemplary embodiments of the present invention, it is possible to protect important information input by a user.

According to exemplary embodiments of the present invention, it is possible to reinforce the security of an electronic device by enabling various types of electronic devices using a touch screen or a touch panel to encrypt information, input via the touch screen or the touch panel, using a touch integrated circuit (IC).

It may be possible to prevent or reduce the risk of hacking issues by encrypting information, input via the touch screen or the touch panel, using the touch IC.

According to exemplary embodiments of the present invention, a touch IC may is directly encrypt information without intervention of a main processor and may directly transmit the encrypted information to an outside server via a communication module. Therefore, if the main processor is hacked, it is possible to protect important information.

The exemplary embodiments according to the present invention may be recorded in transitory or non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus to secure input data, comprising:
a touch panel to receive an input data;
a touch integrated circuit to encrypt input data; and
a main processor to receive encrypted input data;
wherein the touch integrated circuit blocks the main processor from being aware of the content of the input data.

2. The apparatus of claim 1, wherein the touch integrated circuit blocks the main processor from being aware that the touch panel receives the input data.

3. The apparatus of claim 1, further comprising:
a communication module to transmit the encrypted input data to a server;
wherein if the encrypted input data is transmitted to the server, the touch integrated circuit blocks the main processor from being aware that the touch panel receives the input data and the main processor does not intervene in the transmission of the encrypted input data.

4. The apparatus of claim 1, wherein the main processor is aware that the touch panel receives the input data.

5. The apparatus of claim 1, wherein the touch IC comprises:
a coordinate data obtainment unit to obtain coordinate data of the input data on the touch panel;
an encryption unit to encrypt the coordinate data using a secure key;
a mode controller to activate the encryption unit.

6. The apparatus of claim 5, wherein the mode controller activates the encryption unit if a secure mode entrance signal is received, a reference number, reference pattern, or reference motion is detected by the touch panel.

7. The apparatus of claim 6, wherein the secure mode entrance signal is received from the main processor or from an external server.

8. The apparatus of claim 5, wherein the secure key is a symmetric key or an asymmetric key.

9. The apparatus of claim 5, further comprising:
a converter to convert coordinate data into user input values based on conversion based data for an input interface displayed on the touch panel.

10. The apparatus of claim 9, further comprising a feedback unit to generate a feedback signal and provide the feedback signal to an application or display controller.

11. The apparatus of claim 10, wherein the feedback unit generates the feedback signal before the converter converts coordinate data to user input values.

12. The apparatus of claim 10, wherein the feedback unit generates the feedback signal after the converter converts coordinate data to user input values.

13. A method for securing input data in a touch integrated circuit, comprising:
obtaining a first coordinate data associated with a first touch event of an input of data in a touch panel;
storing the first coordinate data;
determining if an input of data is completed in the touch panel;
generating a first feedback signal;
if the input of data is completed encrypting the first coordinate data using a secure key;
if the input of data is not completed:
obtaining a second coordinate data associated with a second touch event of the input of data in a touch panel;
storing the second coordinate data;
generating a second feedback signal;
determining if the input of data is completed in the touch panel; and
if the input of data is completed, encrypting the first and second coordinate data is using a secure key.

14. The method of claim 13, further comprising encrypting the first coordinate data as a first encryption target and the second coordinate data as a second encryption target.

15. The method of claim 13, further comprising encrypting the first coordinate data and the second coordinate data as a single encryption target.

16. The method of claim 13, further comprising converting the first coordinate data to a first user input value after storing the first coordinate data and if the second coordinate data is obtained, converting the second coordinate data to a second user input value after storing the second coordinate data.

17. The method of claim 13, further comprising converting the first coordinate data to a first user input value after determining if the input of data is completed and if the second coordinate data is obtained, converting the second coordinate data to a second user input value after determining if the input of data is completed.

18. A method for securing user input data in an electronic device, comprising:
in a secure mode, providing an input interface to receive input data;
blocking a main processor from being aware of the content of input data;
receiving coordinate data about a touch event in a touch integrated circuit;
encrypting the coordinate data in the touch integrated circuit using a secure key; and
transmitting the encrypted coordinate data.

19. The method of claim 18, further comprising blocking a main processor from being aware of an input interface receiving input data.

20. The method of claim 18, wherein transmitting the encrypted coordinate data is transmitted to the main processor or a server, and if the encrypted coordinate data is transmitted to the server, the main processor does not intervene in the transmission of encrypted coordinate data.

21. The method of claim 18, wherein the input interface is an audio interface.
